(19) United States
(12) Patent Application Publication
(10) Pub. No.: US 2025/0182015 A1
(43) Pub. Date: Jun. 5, 2025

(54) SYSTEM, METHOD, AND APPLICATION FOR TIME TRACKING AND COST CODE ALLOCATION

(71) Applicant: Logistiikka, LLC, Sandy, UT (US)

(72) Inventors: Josiah SAUNDERS, Sandy, UT (US); John SAUNDERS, Sandy, UT (US)

(21) Appl. No.: 18/960,239

(22) Filed: Nov. 26, 2024

Related U.S. Application Data
(60) Provisional application No. 63/604,646, filed on Nov. 30, 2023.

(51) Int. Cl. G06Q 10/0631; G06F 3/04847; G06Q 40/12

(52) U.S. Cl. CPC G06Q 10/06313; G06F 3/04847; G06Q 40/125

(57) ABSTRACT

A system and method for time tracking and cost code allocation combines a graphical user interface slider with the concept of distributing time blocks across a selection of multiple cost codes. The slider provides a way for a user to distribute time across multiple cost codes according to the user's own assessment of where work efforts were more exactly performed on the job. The slider works independently but in direct correlation with each time block. A time block is somewhat “suspended” with regards to assigning a cost code to a worker's time and is distributed later using the slider.

### FIELD OF THE INVENTION

The present invention relates to a method and a system of time tracking and cost code allocation.

### BACKGROUND

Existing methods for tracking time and assigning cost codes to hours and minutes worked by individuals on a given project (i.e., work order, job) are restrictive and rather inaccurate due to the impractical approach of having to assign cost codes in a linear manner. The linear manner of assigning codes is used to track certain tasks (i.e., activities, functions, subprojects) for analyzing budgets, job costs, and other cost accounting objectives. Typically, the process for assigning codes to tasks is achieved by means of a person either (1) assigning a code in advance before completing a “clock-in” time entry for a given individual, or (2) after the fact, once an individual has completed a “clock-out” time entry, as part of editing an existing time entry.

Regardless of which approach is utilized to assign codes to the corresponding tasks, existing methods fail to conveniently derive accurate job cost data. In most construction trades or industries where multiple tasks are involved, the person assigning a code can seldom anticipate which type of work the individual will be performing before the work has commenced. Additionally, in the case where a code may be assigned after the fact, it is unlikely that a single code would aptly capture the multiple tasks as performed. Existing methods of cost code allocation (e.g., drop-down menus, manual entry of codes, etc.) do not provide an approach for the user to dynamically distribute or synchronously allocate time worked among multiple codes. These inherent problems further support the assertion that existing methods are imprecise and inadequate for the intended purpose of time allocation for completed tasks. Thus, there is a need for a more effective method to assign cost codes to time worked on a project.

### SUMMARY

The disclosed time tracking solution introduces a more effective method for assigning cost codes to actual time worked on a project by combining interdependencies of a graphical user interface (GUI) slider together with the concept of distributing “time blocks” across a selection of multiple cost codes. Although sliders are present in GUI applications, the practicality of using a slider for assigning a code is largely ill-suited because assigning a code to a task is a single, isolated affirmation, with no need for the quantification or measurement aspect inherent with a GUI slider.

Additionally, in practice, sliders are difficult to manipulate on certain devices. Particularly on touch interfaces, the level of control needed to meticulously operate a slider to an exact value is unrealistic. The disclosed time allocation solution, however, utilizes a GUI slider functionality and provides a way for a user to distribute time across multiple codes according to the user's own assessment of where work efforts were more exactly performed on the job. The present disclosure provides a new method that creates a more effective process for deriving accurate job cost data. The disclosed GUI slider works independently, but also in direct correlation with each time block. Each time a user clocks in and then out of a given job, the time block is appended to capture the cumulative time of all users (e.g., workers) on a given day. The time block can be augmented as many times as a user might clock in and then out of a given job within the same day. A time block is “suspended” with regards to assigning a code to a user's logged time. In other words, the user is not required to immediately associate a code to any particular task as part of the typical, linear process of clocking in and out of a job, as is the case with existing methods. The suspended time block is distributed later using a more flexible approach.

All time entries for users who have “clocked out” (i.e., workers who have logged time spent on a project) appear in the application as “time blocks.” Time blocks are independent elements created by virtue of users having clocked out of one or more jobs on a given day. The term “time block” is defined as a culmination of time amassed by an individual in association with a given job on a given day, i.e., a time block is the summation of the declared accumulation of time and is the central focus of what gets allocated. A time block can be augmented by virtue of modifying an individual's time. For instances where multiple individuals are selected for allocation of their time, a time block could be looked at as a singular unit, e.g., a time block segment, to be distributed among the selected individuals, proportionate to each person's cumulative time when compared to the whole. In other words, a time block encompasses all time for all users who accumulated time on a given job and continues to aggregate time for as many instances wherein a user clocks in and then out of a given job on a given day. At this stage, the time blocks are not connected or referenced to predetermined cost codes.

Once time blocks are prepared and arranged for cost code assignment, the user has several options as to how to distribute the time among the predetermined codes. This is accomplished by using a GUI slider. A user initially selects which individual(s) will be considered for distributing time across the cost codes that relate to a certain job. Cost codes are subsequently displayed in the form of one or more GUI sliders, wherein the user is allowed to move a corresponding indicator of a GUI slider to declare an amount of time or an appropriate percentage complete for a certain cost code. The process is repeated for any subsequent codes until the total amount of time within the time block segment, including one or more time blocks, has been completely allocated (i.e., 100%). During cost code allocation, users can effectively all selected time blocks in accordance with corresponding cost code sliders.

In an embodiment, a method for tracking time allocated to projects includes logging time spent on a project by at least one individual and allocating time spent on a project across multiple cost codes using at least one slider of a graphical user interface on the user device. The slider is configured to automatically adjust proportionally to each cost code after all time has been allocated. This process allows for a more concise entry of cost codes and avoids overallocation. After all time has been allocated, extending a slider beyond a previously set position initiates both a continuous extension tool and auto-adjustment tool to decrease another slider proportionally to extension of the slider. The slider may also comprise a slider lock tool to prevent said slider from changing time allocated for a corresponding cost code. In an embodiment, other cost code categories are not adjusted proportionately; rather, adjustments are imposed on the adjacent cost code only.

The time spent on a given task determines the total percentage complete for the at least one slider. The process of allocating time spent on a project is incomplete until the total percentage complete for all sliders has reached 100%. In an embodiment, allocation of 100% is guaranteed by design of a single slider for allocating time across multiple cost codes.

The multiple cost codes are selected from a displayed array of cost codes on the user device to provide a simplified step of identifying relevant cost codes without manually inputting numerical values that correspond to the cost code. The cost codes correspond to tasks performed by the at least one individual during the time spent on the project.

In an embodiment, the slider is part of an array of sliders configured as a plurality of horizontal bars, wherein each slider comprises an indicator (i.e., graphical icon) for individually adjusting time allocated for each cost code. A selection of multiple cost codes from a displayed array of cost codes on the user device results in a slider comprising one or more indicators, the number of indicators is automatically generated as being one less than the number of selected cost codes. In an embodiment, the slider is a single GUI track having at least one indicator or icon to allocate cost codes, wherein adjustments to indicators are imposed on adjacent cost codes. The slider allows for users to distribute time across multiple codes according to the user's own assessment of where work efforts were more exactly performed on the job. The derived job cost data is thus achieved without specific, manual quantification and precise recording of the start and stop times. Additionally, the slider allows for the user to dynamically distribute or synchronously allocate time worked among multiple codes, wherein time for multiple individuals can be simultaneously allocated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. In general, the various aspects of the time allocation system and method may be combined and coupled in any way possible within the scope of the invention. These and other aspects, features and/or advantages of the time allocation solution will be apparent from and elucidated with reference to the embodiments described hereinafter.

### BRIEF DESCRIPTION OF THE DRAWINGS

In order to describe the manner in which the advantages and features of the systems and methods described herein can be obtained, a more particular description of the embodiments briefly described above will be rendered by reference to specific embodiments thereof which are illustrated in the appended drawings. Understanding that these drawings depict only typical embodiments of the systems and methods described herein, and are not therefore to be considered to be limiting of their scope, certain systems and methods will be described and explained with additional specificity and detail through the use of the accompanying drawings in which:

FIG. 1 is a schematic diagram depicting an exemplary time tracking system and computing device in accordance with an embodiment of the present disclosure;

FIGS. 2A-2D illustrate example views of a time tracker graphical user interface on a user device for interacting with a time allocation module described herein;

FIGS. 3A-3D illustrate example views of a cost code allocation graphical user interface on a user device for interacting with a time allocation module described herein;

FIGS. 4A-4B illustrates additional example views of a cost code allocation graphical user interface on a user device, similar to FIGS. 3B-3D, wherein time for multiple individuals is simultaneously allocated;

FIGS. 5A-5B illustrate example views of a cost code allocation graphical user interface for reporting time allocation of multiple individuals that worked on a job;

FIGS. 6A-6B illustrate example views of a cost code allocation graphical user interface and corresponding slider for allocating time to individual cost codes;

FIGS. 7A-7B illustrate example views of a cost code allocation graphical user interface and corresponding slider for allocating time to individual cost codes;

FIGS. 8A-8D illustrate example views of a modification to allocate time for an additional individual involved in the same job depicted in FIGS. 5A-5B, effectively retracting the previous allocation for the selected individual(s) for the pre-defined job, then reallocating time per the newly selected cost codes;

FIGS. 9A-9C illustrate example views of a cost code allocation graphical user interface and corresponding slider for allocating time following the modification depicted in FIGS. 8A-8D;

FIG. 10 illustrates an example view of a cost code allocation graphical user interface and corresponding sliders comprising auto-adjustment and locking features; and

FIG. 11 illustrates alternative slider embodiments of a cost code allocation graphical user interface.

### DETAILED DESCRIPTION

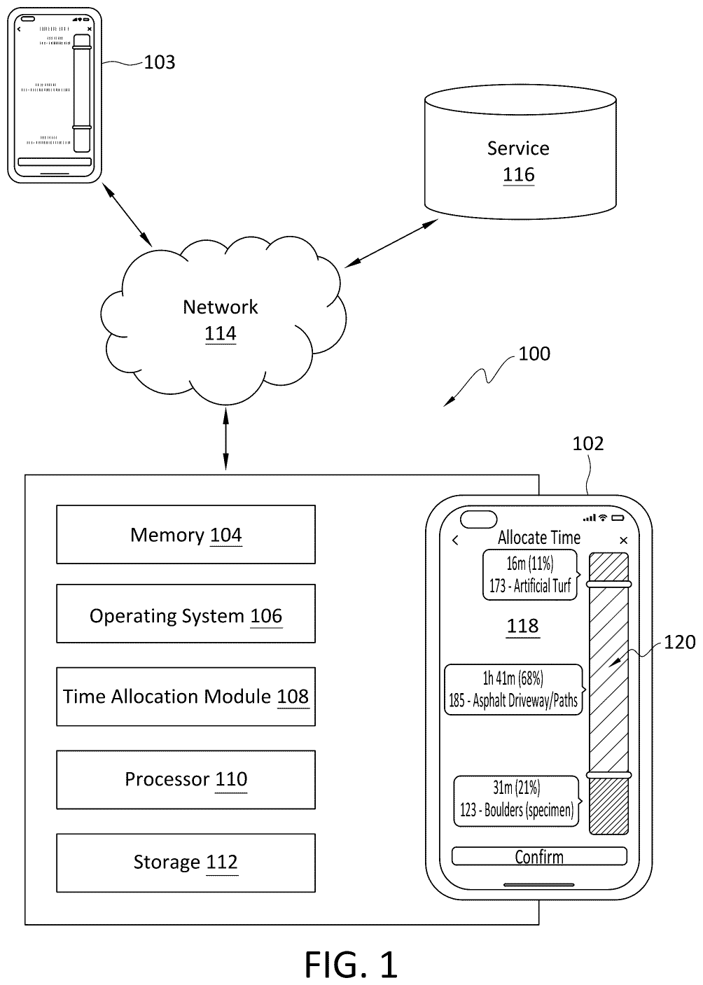

FIG. 1 is a schematic diagram depicting an exemplary time tracking system 100 and user device 102 in accordance with an embodiment of the present disclosure. The user device 102 is depicted as a mobile computing system (e.g., smartphone); however, the term user device is meant to encompass any electronic device capable of processing, receiving, and/or transmitting data or instructions.

The user device 102 comprises a memory 104 (e.g., system or main memory); an operating system 106 and/or one or more application programs (e.g., mobile applications) or services for implementing the features disclosed herein, including a time allocation module 108, wherein the operating system 106 serves as an interface between any hardware or physical resources of the user device 102 and a user; a processor 110 (e.g., a single processor, or a plurality of processors), to execute the method of time tracking and cost code allocation for the time tracking system 100; removable storage and/or non-removable storage 112 (e.g., a single computer-readable storage medium, or a plurality of computer-readable storage media); a display system 118, which includes a main display screen having a plurality of graphical display elements, and may further include other components of the user device 102 (such as one or more light-emitting elements aside from the main display screen), to display the graphical user interface 120.

As shown, time tracking system 100 includes a network 114 (e.g., via Bluetooth, Wi-Fi, the Internet, or a combination of networks) for interconnecting user devices 102, 103 and/or a service 116 (i.e., a single computer system, or a plurality of computer systems). In an exemplary embodiment, user devices 102, 103 and service 116 include a network interface (e.g., one or more network interface cards) to connecting to the network 114. In some examples, the network 114 may include any one or a combination of many different types of networks, such as cable networks, the Internet, wireless networks, cellular networks, satellite networks, other private and/or public networks, or any combination thereof.

The time tracking system 100 in FIG. 1 also depicts a service 116. As used herein, the term “service” refers to an automated program that is tasked with performing different actions based on input. In some cases, service 116 can be a deterministic service that operates fully given a set of inputs and without a randomization factor. In other cases, service 116 can be or can include a machine learning (ML) or artificial intelligence engine. In some implementations, service 116 is a cloud service operating in a cloud environment. In some implementations, service 116 is a local service operating on a local device, such as the user device 102. In some implementations, service 116 is a hybrid service that includes a cloud component operating in the cloud and a local component operating on a local user device 102. These two components can communicate with one another. Service 116 is generally tasked with obtaining, accessing, or otherwise determining time tracking and code allocation data collected using the time allocation module 108. In an embodiment, the service 116 is communicatively coupled (locally or remotely) to a database comprising electronically structured information or data collected using the time allocation module 108. The database stores information related to users, jobs, time, cost codes associated with the time tracking system 100. The service 116 may also comprise database servers, including without limitation those commercially available from Oracle Microsoft®, Sybase®, and IBM®.

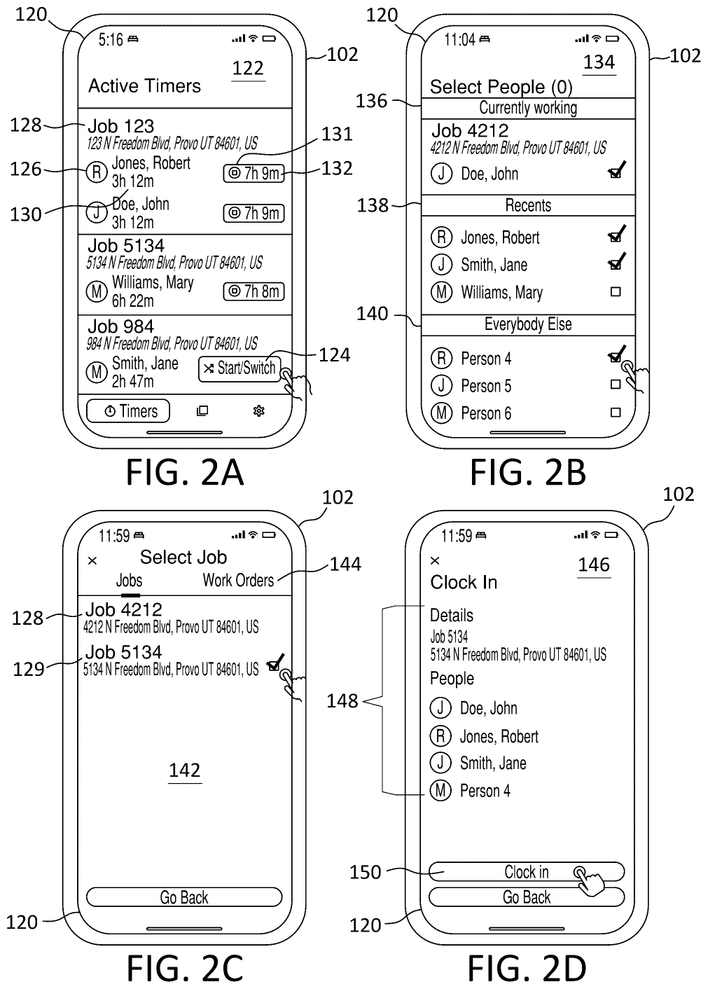

In some examples, the time allocation module 108 may be configured to provide the graphical user interface 120 and implement the other features described herein. The time allocation module 108 is an application program that may be used in a variety of settings. For example, the time allocation module 108 can form part of electronic device (i.e., tablet, computer, smartphone, smartwatch) or the time allocation module 108 can be downloaded and executed by a computer processing unit (e.g., processor) of a user device 102. The time allocation module 108 provides a safe, secure, and durable program for tracking time and allocating cost codes. For example, the time allocation module 108 will, preferably, restrict third parties from accessing user specific or identifiable information, and also protect against viruses and other types of malware or methods of stealing personal information. The time allocation module 108 includes a graphical user interface 120, implemented on the display system 118 of a user device 102, that offers a more effective method for assigning cost codes to time worked on a job or project. The graphical user interface 120 features several displays or screens (as detailed in FIGS. 2A-10) that guide a user through the advantageous and intuitive method for tracking time and assigning cost codes. In at least some embodiments, the display system 118 may include a touchscreen component of the operating system 106, such that at least some operations of the user device 102 may be controlled by physical user interaction with elements of the graphical user interface 120 for the time allocation module 108 presented via the display system 118.

FIGS. 2A-2D illustrate example views of a graphical user interface 120 on a user device 102 for interacting with a time allocation module 108. FIG. 2A depicts an active timer screen 122 that is configured to display a first time 130 (e.g., minutes) being accumulated by each individual worker 126 currently clocked into a job 128. The term “worker” generally refers to an individual that has worked or has been assigned to work on a specific project or job. The term “worker” may also encompass user, individual, person, or more than one person (i.e., company, team, organization, entity). If no workers are clocked in, the active timer screen 122 displays as blank. The active timer screen 122 also displays the cumulative second time 132, depicted as an icon, worked for the entire day or predefined period (e.g., shift), which includes the time 130 showing in for the current job 128. A user may select a stop icon 131 to stop or pause the accumulation of time for the current day or shift. The user initiates the process of tracking time by selecting the “Start/Switch” icon. Selecting the start/switch icon 124 displays the worker selection screen 134 to allow the user to select from the list of workers who are either currently working or not working, and re-assign them to or from another job. The user can start, pause, or stop time for one or more workers at any point throughout the day. The user can also switch jobs for one or more workers without the need to pause or stop the timer. The active timer screen 122 is the main interface for initiating and collecting time tracking data for all workers. At the end of each day, once the user has clocked out all workers for the day, the active timer screen 122 resets and displays as empty.

FIG. 2B depicts the worker selection screen 134 as comprising a plurality of status displays. The worker selection screen 134 allows a user to select workers from a display list of three different groups: currently working 136, recently working 138, and all others 140. The currently working 136 display includes workers who are currently clocked in or actively working on a job. The recently working 138 display includes workers who are not currently working, but have clocked in recently (i.e., within five days, two days, one day). The all others 140 display includes all other workers listed within the database of the time tracking system 100. In an embodiment, the all others 140 display includes workers listed in currently working 136 and recently working 138 displays and features an icon or marker to distinguish currently working 136 and recently working 138 workers from other workers listed in the all others 140 display. Selected workers will be clocked into a job for purposes of tracking time for payroll and job costing. For instances where a user selects a worker who is currently working on a job (e.g., job 128), the time allocation module 108 automatically clocks that worker out of the current job (e.g., job 128), and then clocks said worker into the newly selected job (e.g., job 129).

FIG. 2C depicts job selection screen 142 comprising a list of one or more jobs 128, 129. The job selection screen 142 allows the user to assign a job 128 to the selected worker(s) on the worker selection screen 134 who will “clock-in” to work on the assigned job 128. In an embodiment, the job selection screen 142 features a work order icon 144 to display work orders, similar to the depiction of jobs 128, 129 on the job selection screen 142. In an embodiment, the job selection screen 142 advances to the preview screen 146 immediately upon selection of the job 128. As part of the clock-in routine, existing time tracking applications normally provide the for assigning a code to a worker after specifying a job (whether done before or after creating the clock-in/out process); however, the time allocation module 108 of the present disclosure delays code allocation until a later stage. In other words, the time allocation module 108 suspends cost code assignments to allow for a more flexible approach of time distribution between various tasks performed on a job.

FIG. 2D depicts a preview screen 146 comprising various details 148 related to a job 128. The preview screen 146 allows the user to review the selection of worker(s) 126 and the selected job 128 prior to clocking in. Selecting clock in icon 150 begins the process of capturing time and returning the user to the active timer screen 122. The user may also cancel the clock in operation or return to previous screens to edit the selection criteria.

Cost codes are typically predefined by the user based on the construct of the user's accounting or job costing software. The terms “cost codes” or “codes” can likewise refer to work order line items (or work order tasks) for item (or task) allocation. In an embodiment, the time allocation module 108 enables the user to configure codes on the user device 102 itself, independent of third party applications. In an alternative embodiment, the time allocation module 108 looks to a database in the network 114 or service 116 in order to define and present a particular set of cost codes that the user will be able to select. Thus, the user is not required to filter through a drop-down menu or recall individual cost code numbers for time tracking and allocation. Codes can be comprehensive or Job-specific, meaning that although multiple codes may exist, the user has the option to utilize only a reduced set of codes relevant to a given job. Time is typically captured by means of the user selecting a series of on-screen options, such as selecting a worker (e.g., worker 126), selecting a job (e.g., job 128), and then ultimately clocking in the worker so that the time tracking process can begin.

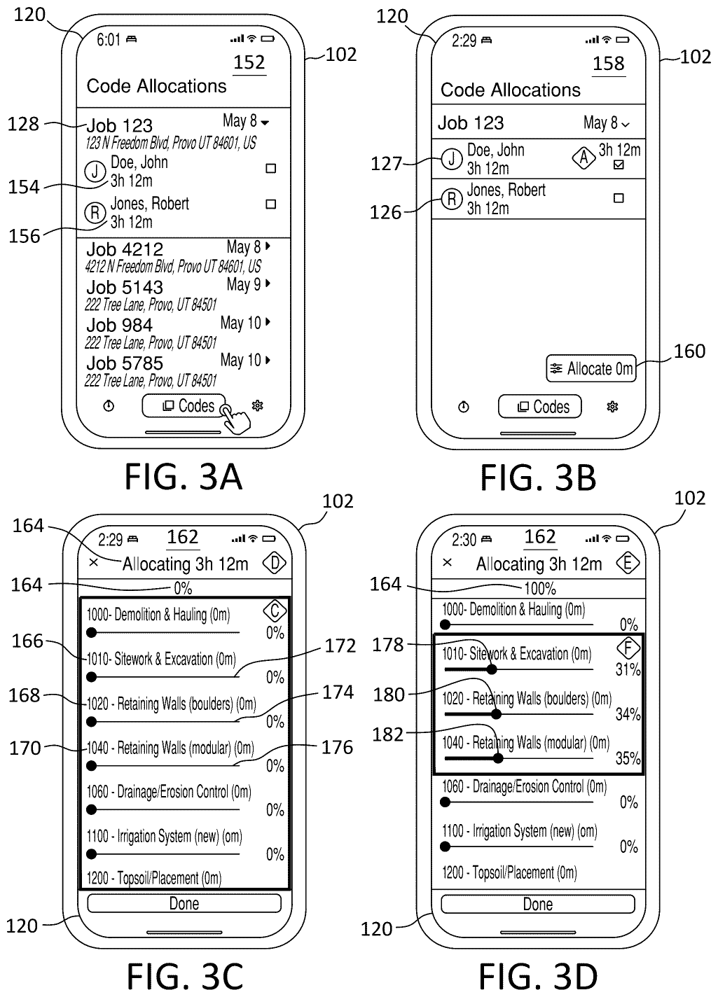

FIGS. 3A-3D illustrate example views of the graphical user interface 120 on a user device 102 for navigating cost code allocation. The code allocations screen 152, as observed in FIG. 3A, contains time blocks 154, 156 that have been captured for a specific job (in this case, job 123) that have been “suspended,” or in other words, on hold until the user initiates the process of distributing time to the appropriate cost codes depicted on the slider screen 162. In an embodiment, the time block (e.g., time block 154) consists of the total time captured for a selected worker (e.g., worker 126) that has accumulated time throughout a given day/shift for that job (e.g., job 128).

FIG. 3B depicts an allocation selection screen 158 that presents the user with an option to select one or more workers 126, 127 for allocating time. The user can select one or more workers 126, 127 when deciding how to best distribute the logged time across one or more codes using the sliders on slider screen 162. FIG. 3B shows the selection of a single worker 127. This selection will send the logged time of that worker 127 for a job 128 (e.g., 3 h 12 m) over to the slider screen 162.

FIGS. 3C-3D depicts the slider screen 162 of the graphical user interface 120 on the user device 102. The slider screen 162 displays all codes 166, 168, 170 relevant to the job 128 that was selected. In an embodiment, codes (e.g., codes 166, 168, 170) are determined by the user, based on the parameters of the selected job (e.g., job 128). In an embodiment, an allocation selection icon 160 is provided to advance from the code allocations screen 158 to the slider screen 162. The slider screen 162 indicates how many hours from the time block the user will be allocating and displays an allocation header 164, including a percentage, corresponding to the logged time. In an embodiment, each code 166, 168, 170 comprises a slider 172, 174, 176 for distributing time between tasks completed for the job 128. Using the sliders 172, 174, 176, configured as horizontal bars, the user has the option to slide or drag corresponding indicators 178, 180, 182 across the horizontal bars in order to determine how much time to distribute to each of the codes 166, 168, 170. Assuming the user selected only a single worker 127 from the code allocation screen 158, the allocation header 164 shows that the user chose to distribute time between codes 166, 168, 170. For example, distributing 3 h 12 m between three different codes 166, 168, 170, wherein the first code 166 corresponds to 31%, the second code 168 corresponds to 34%, and the third code corresponds to 35%, the resulting job costing data would be as follows:
Worker 127
Job 128
   60 minutes to code 166;
   65 minutes to code 168; and
   67 minutes to code 170.

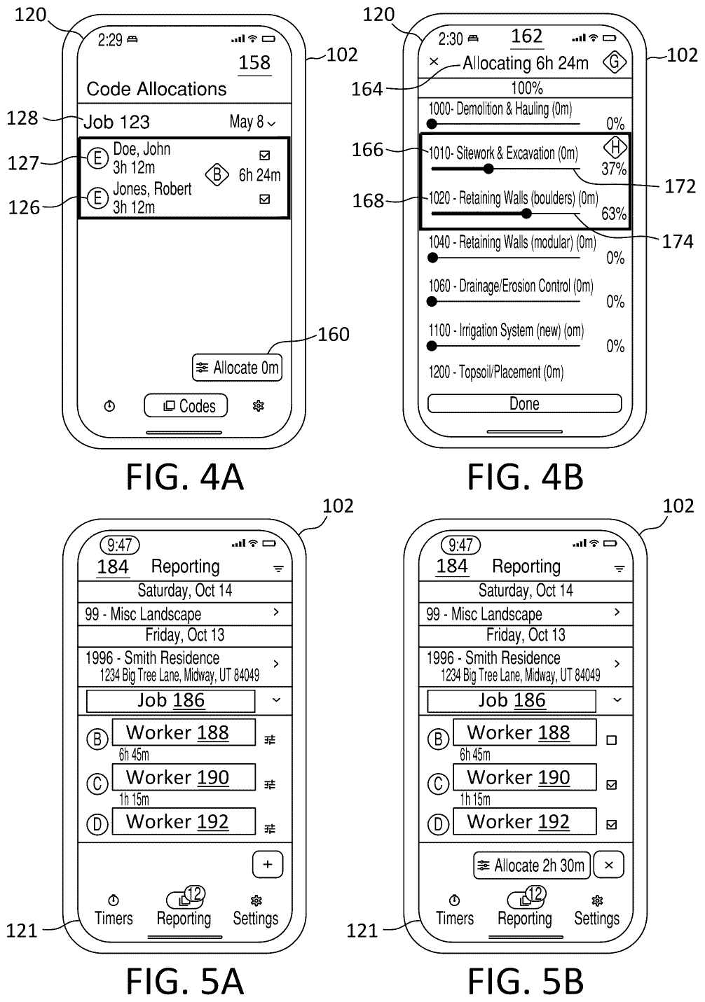

Note: the user of the time allocation module 108 has the option to distribute time for one or multiple workers across any configuration of codes. FIGS. 4A-4B depict additional example views of a cost code allocation graphical user interface on a user device, similar to FIGS. 3B-3D, wherein time for multiple individuals is simultaneously allocated. FIG. 4A shows the selection of two workers 126, 127. This selection will send the logged time of both workers 126, 127 for a single job 128 (e.g., 6 h 24 m) over to the slider screen 162. For example, distributing 6 h 24 m between two workers 126, 127 and two different codes 166, 168, wherein the first code 166 corresponds to 37%, and the second code 168 corresponds to 63%, the resulting job costing data for both workers 126, 127 would be as follows:
Worker 126,
Job 128:
   71 minutes to code 166; and
   121 minutes to code 168.
Worker 127,
Job 128:
   71 minutes to code 166; and
   121 minutes to code 168.

The disclosed time allocation module 108 advantageously allows for users to distribute time across multiple codes according to the user's own assessment of where work efforts were more exactly performed on the job. The derived job cost data, utilizing the graphical user interface 120 of the time allocation module 108, is achieved without specific, manual quantification and precise recording of the start and stop times.

FIGS. 5A-9C provide exemplary illustrations for current time entry allocation and editing time entry allocation comprising an alternative graphical user interface 121 for the time allocation module 108. FIGS. 5A-5B illustrate example views of a graphical user interface 120 for reporting time allocation of multiple individuals assigned to a single job. FIG. 5A depicts a reporting screen 184 that lists one or more jobs 186 and the workers 188, 190, 192 who have accumulated time on the job 186. The reporting screen 184 displays the time block sharing of the three workers 188, 190, 192 for the job 186. FIG. 5B depicts workers 190, 192 as being selected for allocating time spent on job 186.

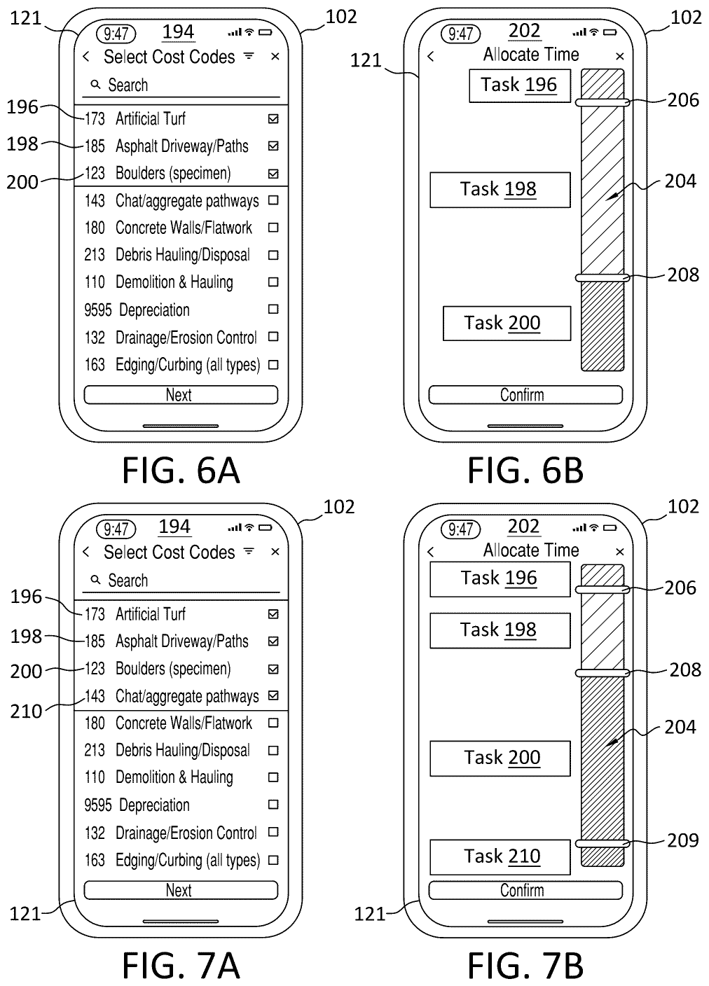

In FIG. 6A, a cost code selection screen 194 displays an array of tasks 196, 198, 200, each corresponding to a unique cost code, that relate to the job 186. The term “task” when referring to an element depicted on the time allocation screen 202, may be interchangeable with the term “cost code.” However, one skilled in the art will recognize that a task generally refers to the action completed by a worker and a cost code generally refers to a numerical code used for benchmarking cost data associated with a physical task. The array of tasks 196, 198, 200 may be displayed in any convenient order (i.e., alphabetical, most common to least common tasks). Displaying the array of tasks 196, 198, 200 advantageously allows a user to quickly select desired tasks for the job 186 for allocation without requiring the use of drop down menus or manual entry of individual, numerical codes. As noted above, existing methods of time tracking and allocation are intrinsically linear and “restricting.” The disclosed time tracking system 100 allows for the user to dynamically distribute or synchronously allocate time worked among multiple codes, wherein time for multiple individuals can be simultaneously allocated.

In FIG. 6B, subsequently displayed time allocation screen 202 of the graphical user interface 121 depicts a single slider 204, configured as a vertical or longitudinal bar, to allocate time between tasks 196, 198, 200. The slider 204 comprises two indicators 206, 208, wherein the number of indicators is generally determined as one less than the number of selected tasks. As depicted, the first indicator 206 controls the time allocation between the first task 196 and the second task 198, and the second indicator 208 controls the time allocation between the second task 198 and the third task 200. The tasks 196, 198, 200 on the time allocation screen 202 may comprise icons or include details to show a title or description of the task, minutes allocated to the task, and/or percentage allocated to the task.

Referring back to FIG. 6A, which generally illustrates a cost code selection screen, it is contemplated that a selection of work order line items (or work order tasks) could be provided in place of cost codes. Such a selection of work order line items could mirror the process of selecting cost codes as depicted in FIG. 6A and subsequently lead to the graphical user interface 121 having a slider 204 to allocate time between work order tasks (e.g., tasks 196, 198, 200).

In FIG. 7A, the cost code selection screen 194 from FIG. 6A is edited to include an additional task 210. The subsequently displayed time allocation screen 202 in FIG. 7B automatically adjusts the previously presented tasks 196, 198, 200 on the slider 204 to account for the new task 210 and adds an additional indicator 209 to allocate the time between the third task 200 and the new fourth task 210.

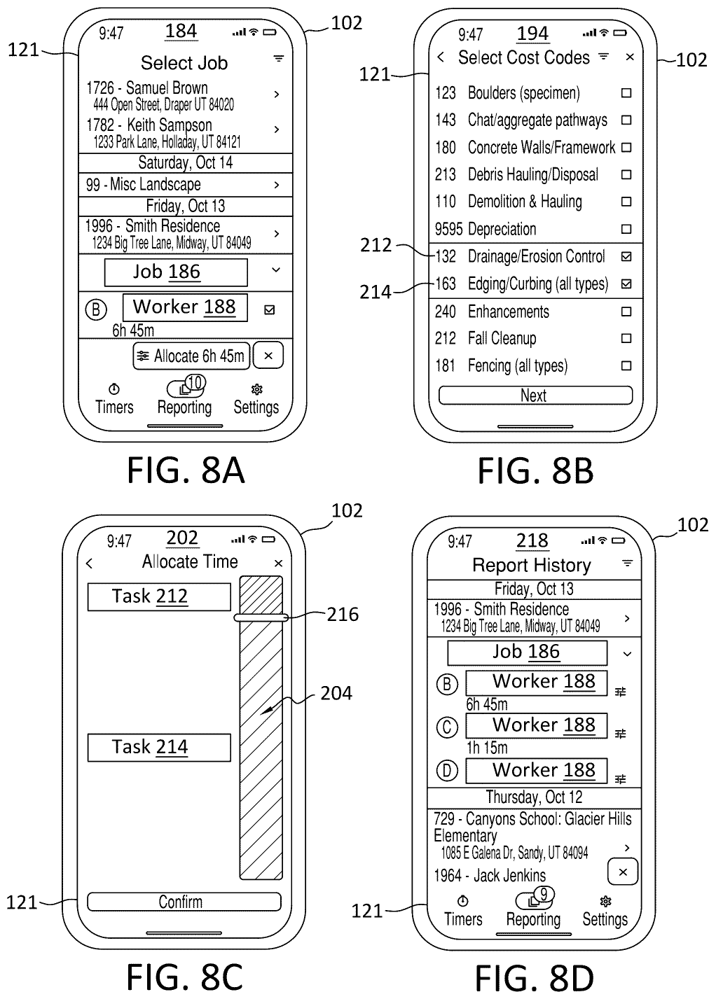

FIGS. 8A-8D illustrates the time allocation for the worker 188 that was not selected in FIG. 5B. On the reporting screen 184 depicted in FIG. 8A, the worker 188 is selected for allocating time worked on job 186. Two new, additional tasks 212, 214 are selected on the cost code selection screen 194 in FIG. 8B. The allocation of time for the job 186 completed by worker 188 between the two tasks 212, 214 is then determined on the time allocation screen 202 using a slider 204 and a single indicator 216. FIG. 8D subsequently displays a report history screen 218 that shows the time blocks for the workers 188, 190, 192 on job 186.

FIGS. 7A-8D also highlight the functionality of re-allocation of the time tracking system 100. In FIGS. 7A-7B, a user is presented with the option to “re-allocate” a previous allocation, i.e., the user has elected to take a previous time block and its associated allocations, then redistribute said allocation among a different set (or a modified set) of cost codes. The process of re-allocation is unique because even though the user may have allocated time for multiple individuals, both of which would have reflected similar allocations proportionate to their time worked, this process “unlinks” the previous allocation and makes the new allocation unique to the new selection of individual(s).

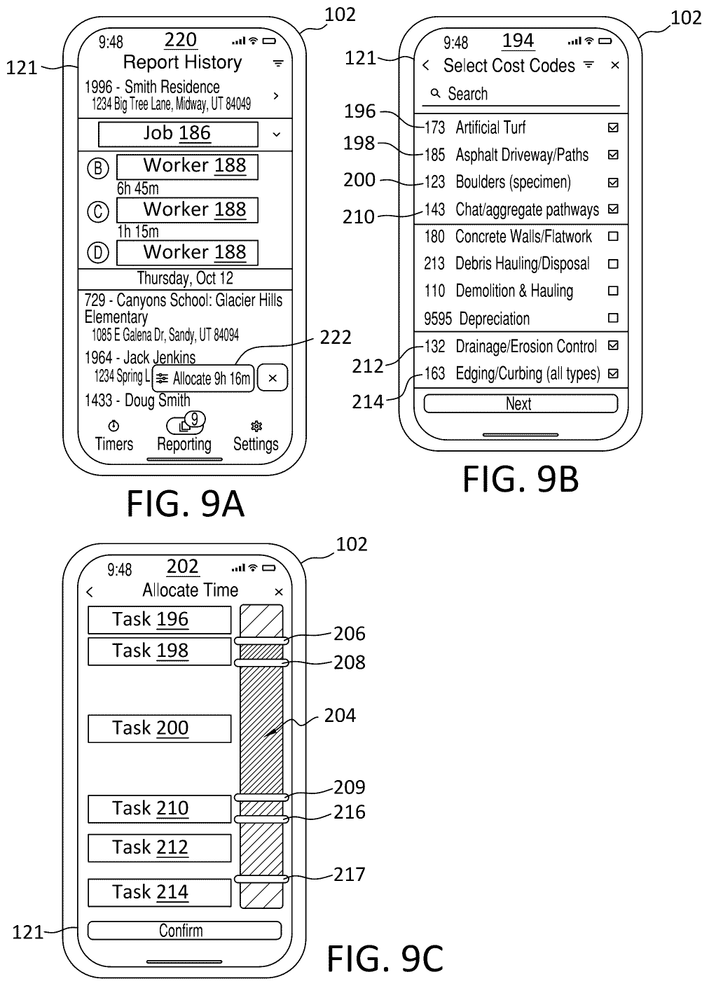

FIGS. 9A-9C illustrate example views of the graphical user interface 121 being used to edit and combine both time allocation entries depicted in FIG. 7B and FIG. 8C. On the report history selection screen 220 in FIG. 9A, time blocks are displayed for workers 188, 190, 192 that relate to job 186. By selecting workers 188, 190, 192, for whom time has already been allocated, and subsequently selecting the allocation selection icon 222, all previously selected tasks 196, 198, 200, 210, 212, 214 appear on the cost code selection screen 194, as observed in FIG. 9B. The time allocation screen 202 in FIG. 9C displays the scenario where tasks 196, 198, 200, 210, 212, 214 from multiple workers 188, 190, 192 are combined and displayed for interactive allocation on the slider 204. As six tasks 196, 198, 200, 210, 212, 214 are displayed, the slider comprises five indicators 206, 208, 209, 216, 217 for adjusting the time allocated to each task, the allocation of which will result in a distribution of time proportionate to the time worked by each of the respective workers.

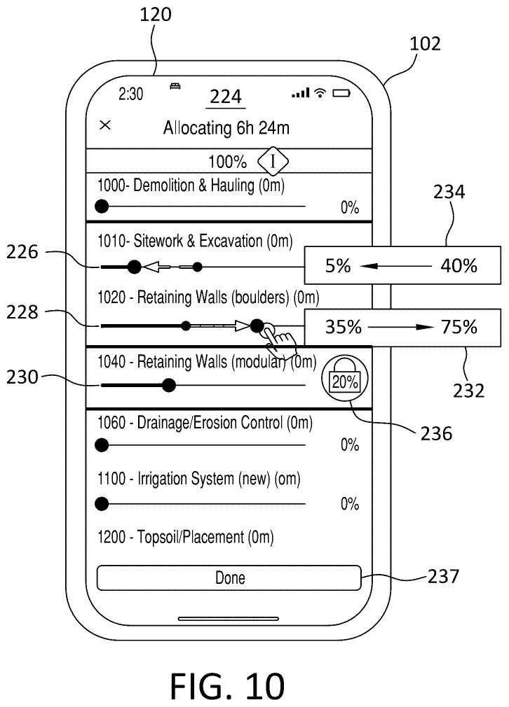

FIG. 10 illustrates an example view of a cost code allocation graphical user interface 120 on an allocation slider screen 224. In an embodiment, the sliders 226, 228, 230 comprise auto-adjustment and locking functionalities. In a preferred embodiment, the simultaneous adjustment of time allocation between tasks is achieved using one or more sliders (i.e., one slider with multiple indicators or multiple sliders with multiple indicators) that automatically adjust proportionally to each task after all time has been allocated.

After all time has been allocated, a continuous extension tool 232 the graphical user interface 120 allows the user to continue extending a given slider 228 beyond its previously set position (e.g., 35%), and increase the code allocation percentage corresponding of that particular slider 228. Extending slider 228 to increase from the previously set position causes all other sliders (e.g., 226) to “auto-adjust” and decrease proportionately to each other using an auto-adjustment tool 236. Referring to the example allocation slider screen 224 in FIG. 10, the slider 228 is increased from 35% to 75% using the continuous extension tool 232, and slider 226 is automatically decreased from 40% to 5% using the auto-adjustment tool 234. FIG. 10 also displays an exception to the auto-adjust feature as a slider lock tool 236. Locking a slider 230 prevents the code allocation percentage from changing for said slider 230; however, other sliders 226, 228 may be adjusted as necessary. The total code allocation percentage for all sliders 226, 228, 230 for any job is prevented from exceeding 100%. Once the allocation reaches 100%, the system enables a done button 237, allowing the user to close the screen and record the declared allocation percentages. In an embodiment, the done button 237 is disabled unless the allocation reaches 100%. Thus, the disabling/enabling functionality of the done button avoids problems of unaccounted time.

One will appreciate, in view of the present disclosure, that the particular shapes, forms, relative sizes, and/or other granular aspects of the components or features of the embodiments of the graphical user interface described herein and shown in the figures are provided by way of example only and are not limiting of the principles described herein. For instance, the sliders, indicators, and icons shown and described hereinabove are not limiting of the principles described herein, and various types of graphical user interface elements may be implemented in the time allocation module 108 of the present disclosure.

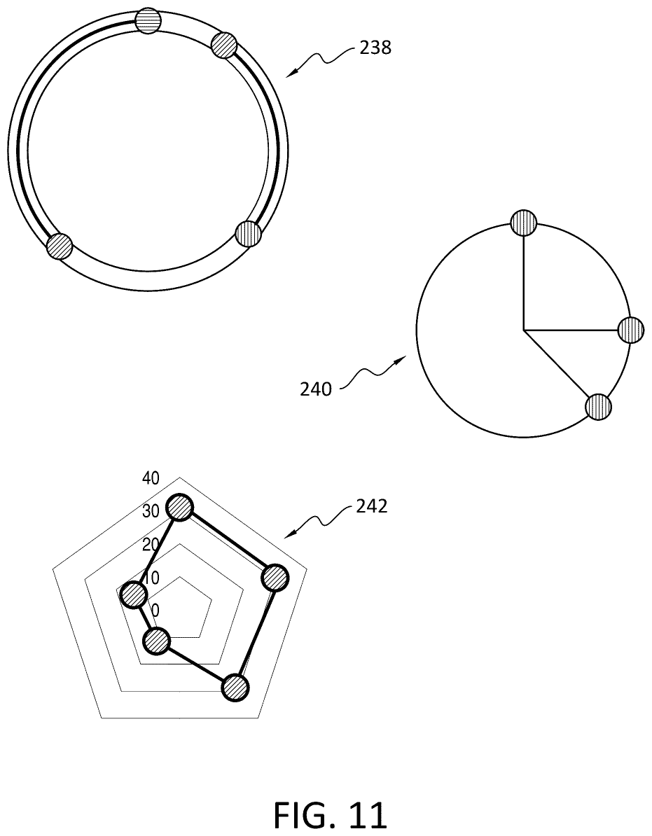

For instance, FIG. 11 illustrates alternative slider embodiments of a graphical user interface (i.e., graphical user interface 120, graphical user interface 121) for cost code allocation. In an embodiment the graphical user interface utilizes a radial slider 238. The radial slider 238 allows users to adjust indicators about a circular track. In an embodiment the graphical user interface utilizes a pie slider 240. The pie slider 240 is configured as a pie chart to show a graphical representative of time allocation. In an embodiment, the graphical user interface utilizes a radial slider 242. The radial slider 242 may be enabled for time allocation scenarios having three or more cost codes, wherein the number of cost codes determined the shape of the radial slider 242 (i.e., selecting three cost codes generates a triangle, selecting four cost codes generates a square, selecting five cost codes generates a pentagon).

Furthermore, the features and/or components of one embodiment, example, or figure discussed, shown, or suggested hereinabove may be combined with features and/or components of other embodiments, examples, or figures discussed, shown, or suggested herein to provide embodiments, examples, or implementation variations that are not explicitly verbally or visually described or shown herein.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present disclosure may be embodied in other specific forms without departing from its essential characteristics. Such embodiments may include a data processing device comprising means for carrying out one or more of the methods described herein; a computer program comprising instructions which, when the program is executed by a computer, cause the computer to carry out one or more of the methods described herein; and/or a computer-readable medium comprising instructions which, when executed by a computer, cause the computer to carry out one or more of the methods described herein. The described embodiments are to be considered in all respects only as illustrative and not restrictive. All changes which come within the meaning and range of equivalency of the claims are to be embraced within their scope.

It is to be understood that even though numerous characteristics and advantages of various embodiments of the present disclosure have been set forth in the foregoing description, together with details of the structure and function of various embodiments thereof, this detailed description is illustrative only, and changes may be made in detail, especially in matters of structure and arrangements of parts within the principles of the present disclosure to the full extent indicated by the broad general meaning of the terms in which the appended claims are expressed.

1. A method for tracking time allocated to projects, said method being implemented on a user device having a processor, comprising:
logging, on the user device, time spent on a project by at least one individual;
selecting multiple cost codes relating to the time spent on the project by the at least one individual;
generating time blocks for display on a graphical user interface at the user device, the time blocks being distributed across the selection of multiple cost codes; and
allocating, on the user device, time spent on the project across the multiple cost codes using at least one slider of the graphical user interface on the user device to adjust the time blocks on display;
wherein adjustment of the at least one slider on the graphical user interface automatically adjusts the time spent on the project proportionally to each cost code after all time has been allocated.

2. The method according to claim 1, wherein the multiple cost codes are selected from a displayed array of cost codes on the user device.

3. The method according to claim 1, wherein the cost codes correspond to tasks performed by the at least one individual during the time spent on the project.

4. The method according to claim 1, wherein the at least one slider is an array of sliders configured as a plurality of horizontal bars.

5. The method according to claim 1, wherein the at least one slider comprises at least one indicator for individually adjusting time allocated for each cost code.

6. The method according to claim 1, wherein, after all time has been allocated, extending a slider beyond a previously set position initiates both a continuous extension tool and auto-adjustment tool to decrease another slider proportionally to extension of the slider.

7. The method according to claim 1, wherein the at least one slider comprises a slider lock tool to prevent said at least one slider from changing time allocated for a corresponding cost code.

8. The method according to claim 1, wherein the time spent on a project determines a total percentage complete for the at least one slider.

9. The method according to claim 1, wherein allocating time spent on a project is incomplete before a total percentage complete for the at least one slider is 100%.

10. The method according to claim 1, wherein a selection multiple cost codes from a displayed array of cost codes on the user device results in a slider comprising one or more indicators, the number of indicators being one less than the number of selected cost codes.

11. A system for tracking time allocated to projects, the system comprising:
a time allocation module for logging, on a user device, time spent on a project by at least one individual; and
a graphical user interface for allocating, on the user device, time spent on a project across multiple cost codes using at least one slider of the graphical user interface on the user device;
wherein the at least one slider is configured to automatically adjust proportionally to each cost code after all time has been allocated.

12. The system according to claim 11, wherein the multiple cost codes are selected from a displayed array of cost codes on the user device.

13. The system according to claim 11, wherein the cost codes correspond to tasks performed by the at least one individual during the time spent on the project.

14. The system according to claim 11, wherein the at least one slider is an array of sliders configured as a plurality of horizontal bars.

15. The system according to claim 11, wherein the at least one slider comprises at least one indicator for individually adjusting time allocated for each cost code.

16. The system according to claim 11, wherein, after all time has been allocated, extending a slider beyond a previously set position initiates both a continuous extension tool and auto-adjustment tool to decrease another slider proportionally to extension of the slider.

17. The system according to claim 11, wherein the at least one slider comprises a slider lock tool to prevent said at least one slider from changing time allocated for a corresponding cost code.

18. The system according to claim 11, wherein the time spent on a project determines a total percentage complete for the at least one slider.

19. The system according to claim 11, wherein allocating time spent on a project is incomplete before a total percentage complete for the at least one slider is 100%.

20. The system according to claim 11, wherein a selection multiple cost codes from a displayed array of cost codes on the user device results in a slider comprising one or more indicators, the number of indicators being one less than the number of selected cost codes.
